(19) United States
(12) Patent Application Publication
(10) Pub. No.: US 2021/0200913 A1
(43) Pub. Date: Jul. 1, 2021

(54) SYSTEM AND METHOD FOR HANDLING ASSETS FOR FABRICATION

(71) Applicant: Patrick M Baudisch, Berlin (DE)

(72) Inventors: Patrick M Baudisch, Berlin (DE); Arthur Silber, Berlin (DE)

(21) Appl. No.: 16/755,573

(22) PCT Filed: Oct. 11, 2018
(86) PCT No.: PCT/US2018/055523

§ 371 Date: Apr. 11, 2020

Related U.S. Application Data
(60) Provisional application No. 62/571,243, filed on Oct. 11, 2017.

(51) Int. Cl. G06F 30/17; G06F 8/36

(52) U.S. Cl. CPC G06F 30/17; G06F 2111/02; G06F 8/36

(57) ABSTRACT

In one embodiment, a method generates a reusable component. The method comprises generating an export file consumable by the targeted fabrication machine, wherein all or part of the geometry represented by the export file allows translation or rotation or both to reflect a position of an asset in a 3D model containing the asset.

### RELATED APPLICATION

This application claims the benefit under 35 USC § 119 to U.S. Provisional Patent Application Ser. No. 62/571,243filed on Oct. 11, 2017, which is incorporated by reference herein in its entirety.

### BACKGROUND

In our disclosure “System and method for editing 3D models”, filed as PCT Patent Application International Application Number PCT/US2017/042686, on Jul. 18, 2017 (which we will refer to as SME3M), which we hereby incorporate herein by reference in its entirety, we introduced a system that allows inexperienced users to create 3D models for personal fabrication machines, such as laser cutters (and milling machines, 3D printers, etc.) (see SME3M for list of devices and generally for definitions). The system allows non-technical users (“designers”) to assemble complex 3D models from simple building blocks for fabrication machines, which we referred to as “boxels” and from reusable components for fabrication machines, which we called “assets”.

### SUMMARY

The instant disclosure describes how assets can be created, represented, and managed. The creation, representation, and management of assets described herein may be performed using the systems described in PCT Patent Application International Application Number PCT/US2017/042686.

Given that assets incorporate engineering know-how, we argue that they are best created by users with an engineering or technology enthusiast background. The asset creation system disclosed herein is therefore geared towards this target audience, i.e., engineers, technology enthusiasts/early adopters aka makers.

During our studies with representatives of this user group, it became clear that these users expect (1) their user interface to be powerful/complete/full control: must be able to produce anything laser cutters are capable of; (2) their user interface to use their tools, i.e., software these users have already been using for years, i.e., 2D drawing packages, such as the open source tools Inkscape and Open Draw, and to a certain extent Adobe Illustrator.

The resulting user interface which we disclose in the following is therefore low-level and 2D, and largely based on users drawing cutting paths in 2D into predefined 2D template files. The benefit of reverting to 2D here is that it allows making anything laser cutters are capable of doing. While any 3D designer experience for fabrication may to be limited in various ways—it obtains that ability by means of assets.

Users then package their designs up in a format conceptually similar to the extensions of the Firefox and chrome web browsers and share them. We disclose how to encode assets using a standardized, interchangeable format making them re-usable and inter-combinable.

The engineer's experience takes place largely outside the web-based interactive editing system disclosed in SME3M—only for testing and when sharing their results may users access the editor.

### BRIEF DESCRIPTION OF THE DRAWINGS

FIG. 1: The instant invention enables an arts-and-crafts eco system that connects engineers with designers to enable them to create products for customers.

FIG. 2 (a) traditional repositories, such as thingiverse collect and share 2D cutting plans, which are hard to edit and reuse (b) The proposed eco system (here labeled kyub) in contrast, allows designers to design effortlessly and efficiently at a much higher level of abstraction.

FIG. 3: A pair of axle bearings mounted to a plate

FIG. 4: Assets may contain multiple files

FIG. 5: Collecting parts that need to be purchased

FIG. 6: An example export file on an asset

FIG. 7: Included assets labeled in-line

FIG. 8: Reduced representation of an asset as a mere set of connectors.

FIG. 9: Asset template

FIG. 10: Fabricating one assets in the context of a 3D model

FIG. 11: Left: the bearing asset placed on top of one boxel, middle: for the front side, the export for laser cutter initially creates two plates, one from the asset and one from the model itself, right: merging these two plates increases stiffness and reduces fabrication time.

FIG. 12: (a): Algorithm to merge plates for machines that cut from sheet-like material, such as a laser-cutter or 2D cnc mill, (b): algorithm to merge material volume for any volumetric operating machines, such as 3D printer or 3+-axis CNC mills

FIG. 13: Flowchart: exporting a 3D model containing assets to a laser cutter.

FIG. 14: Example asset in OpenSCAD file format

FIG. 15: Flowchart explaining how a parametric asset exports

FIG. 16: Placeholder asset allow users to continue

FIG. 17: An example table structure

FIG. 18: Penalty scores as a distance function

### DETAILED DESCRIPTION

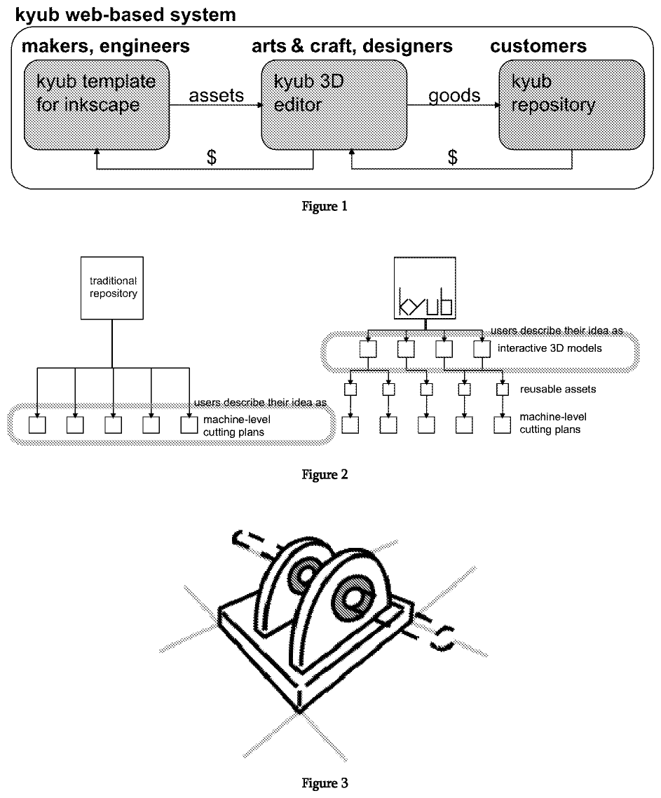

As illustrated by FIG. 1, the combination of the engineering experience disclosed here and the interactive editor disclosed in SME3M can be used to build an eco system that transfers engineering knowledge from users with technical expertise (we will refer to them as makers, technology enthusiasts, or engineers) to users with a vision for a product (we will refer to them as designers) (in order to make products for customers).

At the same time, the instant invention also enables he creation of other types of systems, such as a rapid prototyping system in which there are only designers and customers merge into a single entity. Still assets and in particular a library of assets play a major in allowing users to create advanced rapid prototypes quickly.

Similarly, the instant invention also enables systems, such as architectural model shops, where again designer and customer are the same entity, yet where these users are professionals, thus use their own editing system (such as Rhino, AutoCaD, etc.) instead of the web-based experience described SME3M, resulting in much simpler system in which users simply upload their (architectural, etc.) model and the system returns the model in a form that allows it to be fabricated on an appropriate fabrication machine, such as an .SVG file that can be sent to a matching laser cutter, milling machine, vinyl cutter, etc.

All of these systems may offer different levels of fulfillment. When addressing tech enthusiasts, such systems may for example choose to provide users simply with the machine-executable model, such as the .SVG for the respective machine. When catering to non-technical users, such as certain types of designers, the system may choose to offer complete fulfillment, i.e., users may find a fabricated, assembled, and finished model in the physical mail. When catering to a professional audience, such as architects, both approaches or any level of fulfillment in between (e.g., fabricated, but not assembled) may be viable (e.g., larger offices may afford their own tech equipment, while smaller offices may prefer to receive finished physical models.

Once created and shared, the ecosystem contains one or more asset libraries that collect assets (or an asset store that allows users to purchase assets).

FIG. 2 summarizes the technical concept behind the resulting designer experience and juxtaposes it to the design of traditional repositories, such as thingiverse (or, more precisely. the subset of models contained in it that are designed for laser cutting).

### Assets File Format

The purpose of an asset is to incorporate a piece of engineering know-how. Assets matter, because they allow non-engineers (i.e., users of a higher-level editor) to create complex models that they otherwise would not be able to create or that would force them to undergo a tedious trial-and-error process. A large collection of assets is thus key to the success of users on the designer level and thus the success of the system.

While this know-how can be a piece of design, such as a texture, most assets incorporate engineering know-how, i.e., how to solve a particular engineering problem, such as how to how to hold an axle in place or the such.

This engineering knowledge is most likely held by engineers or technology enthusiasts, such as makers. Consequently, unlike the interactive editor described in SME3M, which was designed to address non-engineers such as designers, the asset interface is designed to address engineers and technology enthusiasts.

The use of the word “interface” might raise the expectation that the following will refer to a graphical user interface or a dedicated software tool that allows users to manipulate assets. However, as we discuss in more detail below, the user experience disclosed below is designed to allow users to use their own tools and thus the “interface” revolves primarily around the description of a file format that allows for this. However, this file format is designed not just for the purpose of storage, but specifically to be manipulated by actual users, so referring to it as user interface may be unexpected, but appropriate.

We also want to allow ambitious non-engineers to create assets—for that purpose, we also present assets created using the designer user interface later in this disclosure; this is easier to use at the expense of being less powerful.

### Requirements

The main design objectives in creating the asset file format include the following.

Complete: (1) Ideally, the asset format should be able to represent anything the target machine is capable of producing. This is of paramount importance, because the editor designed for non-expert use can generally not be complete by itself—completeness can thus only be brought in by means of assets. (2) Allow for any behavior, including behavior that requires code.

Low threshold to get into assets for the target audience, i.e., engineers and technology enthusiasts. (3) Use a format the target audience is already familiar with, (4) that allows them to continue to use their traditional tools, rather than requiring them to learn new tools, and (5) that integrates well into their existing workflow, including (6) testing their designs (e.g., by fabricating assets).

Make remixing easy. Assets address not only the users that will incorporate them into their models, but assets can also be the basis for more assets by remixing. (7) Allow other engineers or technology enthusiasts to use assets as a blueprint for their own assets. (8) For that purpose, make the inner workings of assets easy to understand for other (technologically savvy) users.

Minimize redundancy: In the long-run maintenance plays a major role for any repository. As more and more items accumulate, it gets harder to find anything or to make any major changes to the repository. Thus, (9) we shall try to achieve maintenance by avoiding largely redundant assets. Instead, we shall have very few assets that cover a wide range of cases.

Incentivize the creation of asset. Publicly shared assets are beneficial for the entire user base and especially the non-engineering users of the high-level editor. While some users may be altruistic, more commonly users are not. To still make them create public assets, we might need to incentivize them. (10) One approach is to make assets the only way to solve (certain) engineering problems and then to incentivize or force users to making the resulting assets public. (11) Another approach is to provide financial incentives for creating assets.

Low threshold to create an asset (12) Allow the simplest possible solution to be an asset, even if it is overly specific and thus only useful to a very small number of users. (13) Assets should contain only the relevant contents and avoid syntactical sugar, boilerplate, redundant contents. (14) Allow users to make assets better and more generic, as discussed above, (15) Allow other users to contribute. Encourage role specialization. (16) Since not every tech-enthusiast is able to write program code, code should only be included in assets that truly benefit from its inclusion.

### An Example Asset and How it is Stored=the Format Engineers With Interact With

We will discuss this at the example of a simple pair of axle bearings and at the example of laser cutting. FIG. 3 shows a sketch of such a contraption mounted to a (horizontal) sheet of material. The device consists of two vertical plates mounted to the horizontal sheet by means of finger joints (not visible here). Each plate contains a ball bearing, which in turn holds the axle.

While some assets may choose to glue/screw/nail/tape/etc. assets to the base geometry, the most rigid results can typically be achieved by merging one or more plates in the asset with plates in the base geometry, so that plates in the asset and plates in the base geometry end up as one single plate. In FIG. 3, for example, this would typically be realized by merging what is shown as a black rectangular plate at the bottom of the asset with the plate the asset is mounted onto, resulting in a single plate, just with additional cut-outs for the bearing. Axles etc. may be merged using the same principle.

Assets in the present disclosure can be represented in a wide range of ways. One group of embodiments represents assets as a group of files, some or all of which may use standard file formats. Such files can, for example, be held together by storing them in a folder or folder structure in the file system and then optionally combining them into a single file, e.g., using an archive file format, such as .zip. Another approach is to contain all information in a single file, structured by headers or separators inside the file, etc. Storage is not restricted to a file system, assets and/or their individual parts may, for instance, also be stored in a database system.

As someone skilled in the art will appreciate, there are many ways of accomplishing this, e.g., development and deployment processes similar to those used by add-ons/extensions of common software programs, such as current web browsers (e.g., Chrome, Firefox).

For the example of the axle double ball bearing shown in FIG. 3, the asset may for example be called axleDoubleBallBearing.asset and that file may in reality be a .zip file. E.g., by renaming the file to axleDoubleBallBearing.zip we can now expand the file and view its contents.

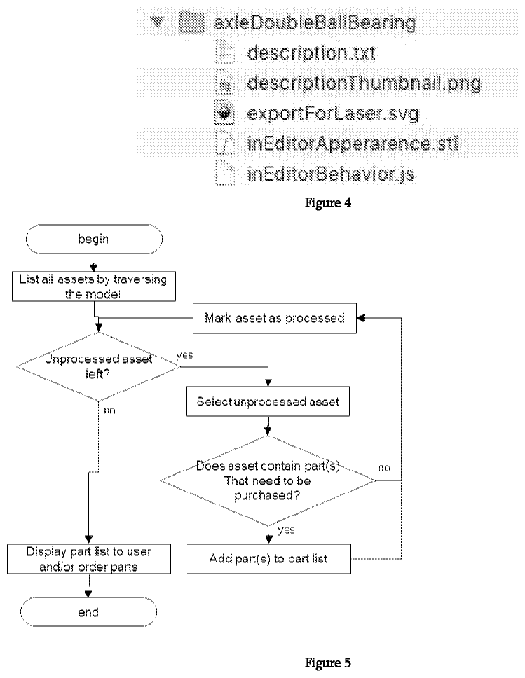

As shown in FIG. 4, the folder may contain a number of files. This particular file contains five files, but other assets may contain fewer or more files. They may be named as shown or use any other naming scheme. Files fall into three groups: (1) Appearance and behavior in an interactive editor, (2) Appearance in a menu or search system, and (3) What will be exported to the fabrication machine. Furthermore, an asset needs to declare its (4) connectivity, but in the shown embodiment this information is merged into another file, so it is not directly visible when inspecting the folder.

### Appearance in an Interactive 3D Editor

Appearance files allow an asset to be used in an interactive editor (here called inEditorApperance.stl). In the shown example, the asset contains a 3D file (.stl), which allows it to be shown in an interactive 3D editor. It does not have to be .stl though and better, more realistic results can be achieved by using more powerful 3D formats, such as .obj, unity3D file formats, any other game engine-related format, formats that allow for color, etc.

Interactive editors may use this appearance file in a process as simple as loading it, translating it to the appropriate location, and displaying it there. In this case, the asset will be rigid and will not allow any further manipulation in the editor, except global operations, such as scaling.

That said, more complex and thus powerful appearance files are possible that allow for multiple parts etc. Also, by adding a description of the asset's behavior the asset may allow for a livelier behavior in the editor. A description of behavior can be as simple as a description of a few properties, such as one or multiple of mass, buoyancy, wind drag, sound on collision with wood, sound on collision with steel, elasticity, young modulus, stiffness, and so on. Such information can be stored in a wide range of formats, ranging from XML, to JSON, to code that assigns values to variables.

On the other end of the spectrum, in behavior may even be described using code. This code may contain functions written in a programming language. In the shown example, inEditorBehavior.js contains JavaScript code, but any other language is possible as well, such as coffee script or other scripting languages, byte code, such as .Java, source code, such as .c, compiled/binary code, such as .exe, various computer aided design formats, such as sCAD, various animation frameworks, game engines, such as Unity3D, etc. or collections of code for multiple platforms.

There are many ways of implementing this code, including calls to predefined functions and the overwriting of certain methods that are called when the object collides, is subjected to a load, immersed in water, and so on. The code may also refer to, access, and control elements in the appearance file, e.g., to animate it. To complement the behavior, an asset may contain additional files, such as sound files to be played on collision, texture files, etc.

Before executing code, a system may check the code to assure correctness and/or freedom from virus-like behaviors.

Appearance files may make reference to/include other appearance files, such as the appearance of a bolt contained in the asset. Appearance files may also make reference to built-in assets, such as plates of wood, etc. for a laser cutter based system.

Appearances can come in a wide variety of levels of detail. Some assets may contain a highly realistic representation, others a low-polygon count 3D model, others some sort of placeholder that essentially just occupies roughly the right amount of space and hints users at how to interact with the asset. In particular, they may show where connectors (see below) might be located, so users know where to connect additional geometries, boxels, and assets.

An asset may contain multiple appearance files, e.g., for different platforms, such as a low-quality version for mobile devices, etc. In order to save bandwidth, an asset server may also offer multiple versions of an asset for different platforms, so each device loads only what it needs.

Under certain circumstance, such as if a file contains no appearance file, the editor system may try to create its own appearance automatically. Some embodiments take the export form file (see below) and assemble it automatically as far as they can for a 3D model using some variation of the .svg importer described in SME3M. Another approach is to use a default placeholder appearance file. The system may offer a global placeholder for any asset, a placeholder for an asset with a certain configuration of connectors, and/or for an asset with a certain functionality. The asset may, for example, describe itself as inheriting from some class, such as a hinge class and the system may then use the default appearance for a hinge. There are many ways how an asset may communicate that it is such a hinge, e.g., in the form of contents in a behavior file, a file name in the asset, and so on. Appearances may also be enhanced by adding imagery from any part of the asset, such as the descriptionThumbnail.png shown in the example above.

### Export File

The export file is an important element if not the most important element in that it generally contains the engineering know-how by describing what exactly will be fabricated.

An export file may make reference to a platform it is designed for. The file exportForLaser.svg does so in the file name Other embodiments may encode this information in the file or in a separate file, etc. An asset may contain multiple export files, e.g., for different fabrication devices or fabrications parameters (in the case of a laser cutter, parameters may, for example, include kerf, materials, etc).

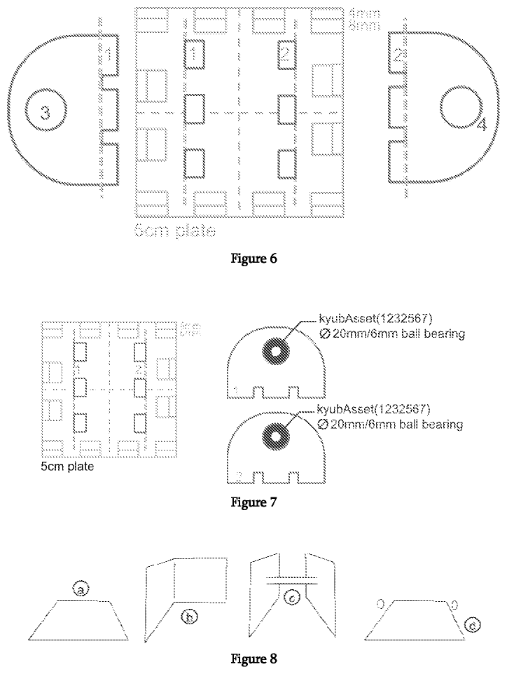

The export file may be encoded in a wide range of formats. In the shown example exportForLaser.svg, for example, is in a 2D drawing format designed for (2-3-axis) laser cutter output. FIG. 6 shows one possible embodiment of such a file. The shown file contains several different types of contents. This particular format specifies the role of each element by means of color-coding, but other embodiments may use other ways to specify what means what (other colors, placing graphics on different layers instead of using colors, using multiple files, distinguish lines by means of annotations, by line texture, by line thickness, etc.).

In the shown example, gray is used to represent connectors; as defined in SME3M, these are points that allow an asset or boxel to connect to other contents, typically other connectors. In the shown example, the asset has a single connector, which is square and measures 5 ×m×5 cm. An asset may contain any number of any types of connectors.

In this particular format, only the rectangular frame matters, as it provides the reference frame of the asset. The system loading the asset will typically search for this rectangle in order to establish its frame of reference (see below for more on what the system does with this).

The other details in gray are immaterial from a systems perspective, but may be included for usability reasons. The shown example file, for example, hints at a set of 4 mm and a set of 8 mm finger joints along the perimeter; these finger joints can help asset authors stay clear of such regions if they expect the asset to be used in contexts where the asset will be mounted with finger joints in these regions, e.g., in the context of certain boxel types. The gray dashed lines help find the center. The text snippets 5 cm, 4 mm, and 8 mm in this example are also there only to inform the user (note that in this case, the “user” will typically be engineers/maker who make assets, not users of the interactive editor).

In the shown example, red is used to represent actual laser cutting. This is the main content that is used to produce the asset by forwarding this geometry to the laser cutter.

The shown example contains two types of red line art. First, some of the red lines are located inside of a connector (here a gray box). This is what we might refer to as the subtractive part of the asset, i.e., these lines represent what has to be cut away from the 3D model when the asset is mounted to in order to attach the asset. Here, this is two sets of finger joints that allow “plugging in” the two plates. Second, the other lines are located outside the connector. This is what we might refer to as the additive part of the asset, i.e., these lines represent what has to be added to the 3D model when the asset is mounted in order to create the additional geometry. Here, this is two plates that contain the holes for ball bearings mounted as press fits.

The main purpose of the export file is to allow the system to fabricate the asset, i.e., when a user triggers the fabrication of an object containing the asset, the system consults the export file to add geometry for the asset. In the shown example, model and asset are to be fabricated using a laser cutter, thus the cutting plan is essentially a line graph, which may, for example, be expressed in .svg format or similar format. So may the asset, making both directly compatible, which simplifies export (otherwise the asset will typically first be converted to the format of the fabrication machine).

Upon export to the fabrication machine, here the laser cutter, the system proceeds as follows. First, it determines where the asset is mounted, i.e., where the connector is located in the cutting plan to be exported. The system now translates and rotates the gray connector including the “subtractive” red lines located inside the connector so that the connector maps directly to the asset's connector in the model's cutting plan. The system now drops the gray lines—they are of no further use—and adds the red lines to the model's cutting plan.

The system now adds all remaining lines to the cutting plan. Unlike the red lines inside the connector, lines outside the connector describe contents to be added. The system adds them to its list objects of parts to be manufactured. When the first pass of the export is complete and all assets have been added to the list, the system optionally dumps all parts from the list into a non-overlapping 2D layout, optionally runs optimizations over it, (e.g., using CutCAD https://hci.rwth-aachen.de/cutcad etc.), e.g., to optimize material use, and fabricates.

Note that the system can perform the export of the asset by simply passing the red lines through to the cutting plan, i.e., without even trying to interpret the lines. This makes this approach complete, efficient, and extensible as any functionality can be added without requiring the system to be modified.

In the shown example, blue is used to represent included assets, i.e., blue means “import the asset with this kyubAsset ID number”. The shown example contains two IDs. The shown example uses a local numbering schema; this may be used with an additional parts.txt or parts.json, etc. file in the asset (not shown earlier) that describes what asset is being referred to. Alternatively, other embodiments place a globally unique asset ID there (see also FIG. 7).

In the shown example, the asset includes two ball bearings—parts that have to be purchased elsewhere rather than being created by the fabrication device. Such assets may also simply be described directly inside the asset file as shown in FIG. 7. Upon export, the system collects all such assets in a separate parts lists (e.g., using a simple depth first traversal of the tree formed by the inclusion hierarchy) and returns them to the user or may trigger an automatic purchase of these parts (FIG. 5). The resulting list may then contain information about the required parts, such as 3, 4: kyubAsset (1232567), 20 mm/6 mm ball bearing

In the shown example, green dashed lines fulfill two purposes. First, they may be used as assembly instructions. For example, the red part on the left includes a green dashed line labeled “1” and then there is another green dashed line also labeled “1” on the base plate. The identical labeling suggests that these two parts are supposed to be assembled. The same line can also be used to suggest the orientation in which this assembly is supposed to take place, namely so that the green lines align; other embodiments may use the “1” annotation to express this alignment. While we use numbers here, such annotations could be any type of ID, including text, imagery, etc. Such assembly instructions may be shown to the user on a screen or in print etc. helping users assemble the asset. Assembly instructions may also be fabricated into the parts. Since this is sometimes desired/acceptable and sometimes not, some embodiments may choose a different color (say orange) to specify that a line will be fabricated into the part, e.g., by engraving using a laser (or milling machine, or by extruding geometry for 3D printing, etc.).

Another benefit of such assembly instructions is that they can allow for assets without explicit appearance files. When the system imports an asset, it may try to use the SVG import process described in SME3M with additional steps that try to automatically assemble the asset. The system may guess what goes where, but annotations take the guesswork out and allow for reliable assembly. Once assembled, the system is able to create a 3D model of the asset, which allows it to automatically generate the appearance. The benefit of assets without explicit appearance file is that they can be created faster and with less human effort.

The second purpose of the green dashed line is that it can serve as a basic parametrization, specifically material thickness. The asset shown in the figure, for example, might have been designed for 5 mm plates. If a user is trying to use this asset with a different material thickness, say 8 mm, the cutouts in the base plate have to be made wider and the finger joints at the bottom of the additional plates have to be extended. Similar adjustments are necessary for various other types of changes, such as for laser cutters with different kerf, to obtain a different engineering fit, or to use a harder or softer or stickier or more slippery material. The green annotations here point out where materials will be joint, thus where adjustments have to take place. Furthermore, the dashed green line can be used to express “alignment”, i.e., in which direction the cut outs are supposed to grow. In the shown example, for example, the cut outs in the base plate would have to grow inwards to leave the dashed green line unchanged.

Not shown in this example, but embodiments may also allow for additional simple forms of parametrizations. A purple line, for example, may suggest for example that an object can be adjusted by “widening the line” or using pairs of lines, suggesting that material can be collapsed between the lines. Additional labels may specify the type and additional parameters for the parametrization, such as a maximal extension allowed. A label or similar may allow exposing the parameter, e.g., in the editor's user interface, allowing users to adjust the parameter.

Also not shown in this example, but embodiments will generally allow adding comments to export files. Such comments, e.g., distinguished from other contents by color, such as black, can help other asset makers understand the design at hand when remixing assets.

The export file may be a single or multiple files.

To help asset creators, such as engineers and makers create their assets, the system will typically share what we call asset template or just templates. There are many ways of making a template, but typically a template will contain one or more “connectors” (shown in gray in the FIG. 6) with optional annotations (also gray in FIG. 6) and maybe comments.

### Connectivity of an Asset

In order for interactive editors to allow users to integrate assets into their designs. they need to figure out how the asset can be “connected” to the existing “base” geometry.

Figuring out how asset and base geometry can be connected can be a complicated task, because the number of potential connections tends to exceed what immediately meets the eye. The asset shown in FIG. 6, for example, can clearly be connected by integrating the rectangular connector plate at its bottom, but then again, other geometry may (also) want to connect to the axle, and on closer inspection there are many other opportunities as well: For example, one could mount the asset by means of integrating with or connecting to the two plates that hold the ball bearings or one might mount other assets to them. Given that the complexity of an asset is conceptually unlimited, so tends to be the number of ways assets can be mounted to and combined with base geometry.

Those embodiments that “unpack” assets during loading, i.e., break them down into plates and other parts, may try to discover all or at least many of the different ways how an asset can be integrated. Since this is a complex endeavor, some embodiments of assets offer an alternative approach that allows connecting assets without unpacking the asset. These embodiments instead allow assets to specify position and type of dedicated connectors, i.e., the connectors we already talked about. This allows the embodiment to integrate assets based on a vastly reduced view of the asset, such as the one shown in FIG. 8 ((a) single square connector asset, (b) two-connector asset at 90 degree angle, (c) two-connector asset at 180 degree angle; the connecting bar in the center is optional and just illustrates that these connectors belong together; as a matter of fact any placeholder could do here. (d) One square connector and two round connectors, e.g., axle connectors). Such a reduced view consists only of connectors alone (with optional decoration for visual clarity), so that, for example, user interactions in an editor can limit its processing by referring to the connectors alone. In contrast, they can handle the rest of the asset as a black box by rendering the appearance file during viewing and editing and passing through the export file during fabrication.

For the single-connector embodiment, such as the one shown in FIG. 6, this is simple. The connector already contains what is needed, including the shape and thus type of the connector; the connector's orientation is here expressed simply by the orientation of the document, the involved text, or any combination thereof. Other embodiments may use arrows pointing up, etc. For symmetric connectors, this allows mounting the asset in a well-defined orientation.

Then again, this may not be all in that this asset also includes the axle and conceptually this axle could be interacting with the rest of the 3D model. A more elaborate version of this asset therefore contains two additional connectors—namely axle connectors. These are very much like the plate connector, but are marked (using what we called “icon” in SME3M) that they want to connect to an axle. (The axle connectors also need to specify where they are located using the approach described below).

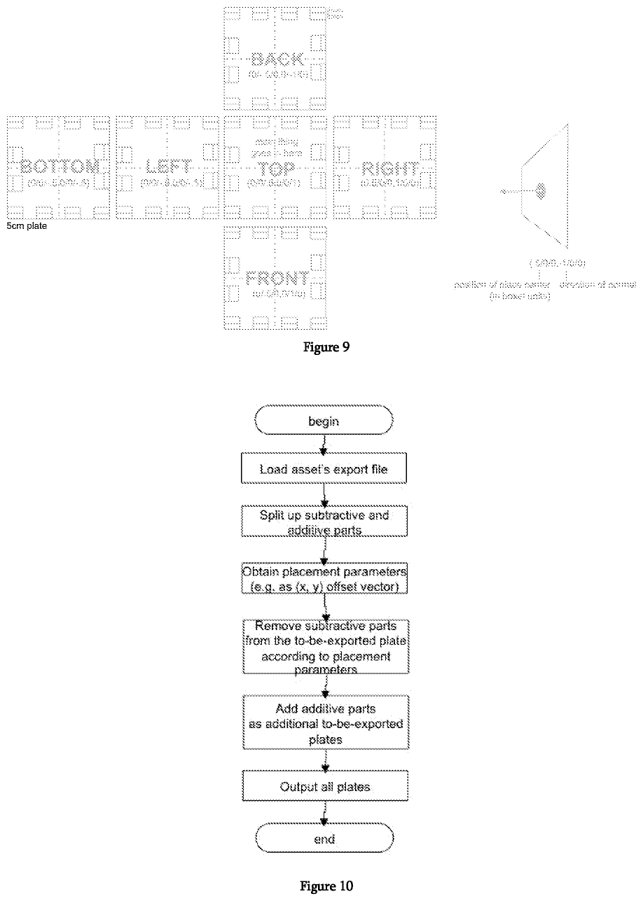

The example template shown in FIG. 9 goes a step further by offering multiple plate connectors. In this situation, embodiments of templates should provide clarification of how these connectors are located with respect to each other in space. The shown example illustrates multiple ways how this can be achieved. First, by means of convention, the cross-like arrangement can be interpreted as a box. Second, labels on the connectors, such as “top”, may be used to express where the respective connector is located. Third, and naturally more encompassing, each connector may be annotated with the connector's position in space. In FIG. 9 this is done as a vector specifying connector center and normal, but someone skilled in the art will appreciate that there are many other formats for expressing this.

Given that such position vectors are inconvenient to understand and edit by humans, templates are a convenient way to hide this information from asset makers. A template may, for example be a file containing the connectors, serving as visual reference for the person creating the asset. The template shown in FIG. 9, for example, could be processed by automatically parsing the vectors but using the layout and symbolic “top”, “bottom”, etc. labels to help human asset makers. In order to keep both types of information consistent with each other, some template files may prevent users from editing this information by making it read-only.

Also, while this format tries to contain information about the asset's connectivity in the export file, this information may instead be stored in many other ways, such as annotations in a 3D appearance file, as a separate connecitivity.txt file, and so on.

Note how templates with multiple connectors allow defining boxels as assets.

Note that the asset user interface for makers and engineers mentioned in FIG. 1 is essentially nothing but a set of templates combined with tools users already have, so that these templates form a substantial part of the user interface. And while asset templates may appear simplistic and unsophisticated at first glance, they do address the requirements stated earlier, in that they are powerful and allows users to continue to use their own tools, etc.

Finally, some embodiments will offer a second way of creating and editing assets and that is by means of the interactive editor, i.e., users create an assembly and simple store that (locally or on a server), declaring it an asset. This approach is more limited in that in that it only allows constructing assets from that the interactive editor is capable of representing. However, it is also very convenient and by addressing a wider audience past the engineers and makers addressed by the template interface it could be called more “inclusive”. Thus, both approaches are justifies and thus many embodiments will want to offer both.

### Fabricating 3D Models Containing Assets

In isolation, an asset in a “line-based” format, as described above, can typically by simply sending it to a fabrication device, here a laser cutter, configured to fabricate the lines and engraving that denote contents (red in our earlier example) and none of the other colors. In this sense, assets are “backwards compatible.”

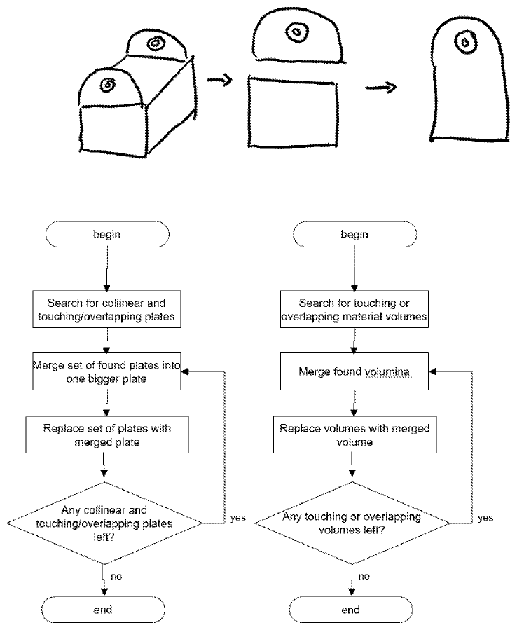

When fabricating a 3D models containing one or more assets, the algorithm that fabricates the model traverses the 3D model and processes it for fabrication. Whenever the algorithm encounters an asset, it processes the asset as described by the algorithm shown in FIG. 10. The algorithm is actually quite basic: since the line-based format is in itself “backwards compatible” the algorithm translates all coordinates in the export file so as to reflect the placement of the asset. It then essentially hands the export file through to the laser cutter.

If the asset should produce additional plates, these plates are collected and at the end laid out on blank material and sent off to fabrication.

### Merging Plates for Extra Stability

If assets add material to the model, such as add plates (which we will also refer to as parts) to a laser cut model. This means the “base” model may contain plates and additional plates might come in from the assets.

In order to increase the stability of the resulting physical object (as well as reduce fabrication time and reduce material consumption) the system is merging plates contained in assets and plates contained in base model as illustrated by FIG. 11, with the objective of creating fewer larger parts.

For laser cutters (or CNC mills or any other machine that cuts out from sheet-like material), the system performs the algorithm described in FIG. 12. The system searches the model for separate plates that overlap and/or touch on the sides, and replaces them with one bigger plate that contains all individual plates. This essentially removes cuts between the individual plates, vastly increasing stability and reducing fabrication time.

If existing parts should be expected to be able to move relative to each other, the algorithm can be extended so as to first group the model into separate sub-groups of material/plates/assets that are not supposed to move relative to each other, then running the algorithm on each sub-group separately.

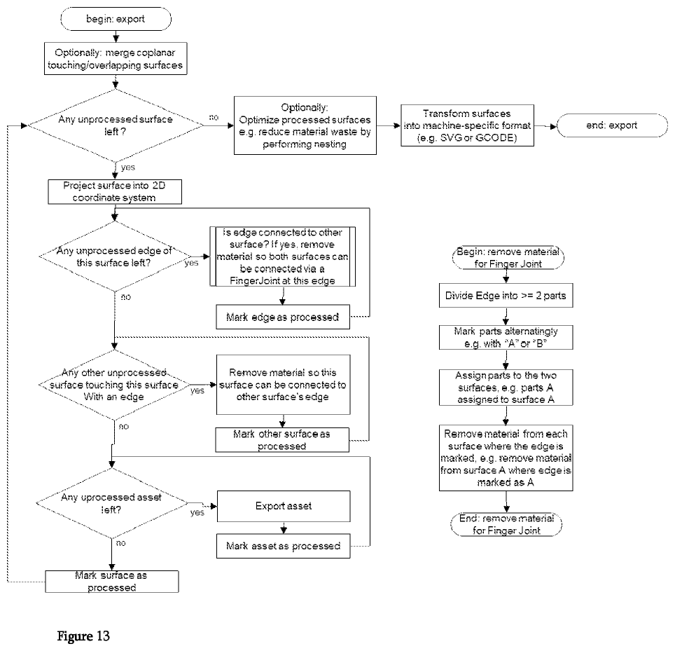

FIG. 13 shows how a flowchart that explains the overall process of exporting a 3D model containing assets to a laser cutter.

### Parametric Assets

In order to obtain maximum value from an asset, that asset should be applicable to a large number of use cases. However, different users may fabricate their models under different external conditions, such as fabrication machines of different kerf, different materials, different material thicknesses, etc. As a result, an asset's exportFile may produce suboptimal results if the external conditions of the person applying the asset vary too much from the external conditions of the person designing the asset.

Some types of assets are not really subject to this challenge though. For example, laser cutter-based assets described using the “line-based” format described above work out well independent of material, material thickness, or kerf, as long as they are placed in a plate with a very loose fit tend to. For the same reasons, they tend to continue to work out when placed along and edge or corner.

However, assets containing parallel plates tend to be sensitive to variations in material thickness and press-fit elements tend to be sensitive to variations in material and kerf, etc. To make such assets work across a wider range of external conditions, the asset may need to respond to changes in these parameters explicitly.

Some embodiments may support assets that are a more parametric, i.e., they may be designed to work not just across multiple material thicknesses, but also multiple materials, machine settings (such as the amount of material removed by the milling machine or the laser cutter (aka kerf)), engineering fit, etc.

For instance, taking the example of the axle mount one step further, we want to make sure that the ball bearings can always be press fit into the surround material, i.e., that it requires a certain amount of force to insert them and that they will then stay in, unless removed with a large force. If we now want to make sure that this asset continues to work when made from wood and acrylic and, say, on laser cutters with different kerf values, the model needs to be adjusted. For example, when switching to acrylic, which is stiffer and more brittle, we may want to make the opening to contain the ball bearing larger, in order to prevent the acrylic from bursting when the ball bearing is inserted. We also want to make sure the opening sent to the cutter reflects the kerf settings, so that we obtain the physical hole size that we intended.

Beyond this, we could add additional parameters, such as a means to add additional bearings for very long axles, or of the axle is to take a particularly high load, etc.

Although some degree of parametricity can be achieved by using file formats such as SVG, TXT or others stated above, some embodiments allow assets with such more advanced types of parameters to be expressed in an algorithmic way, i.e., in the form of a code piece that is executed in order to generate the exact fabrication instructions (such as an .SVG) in the local context in which it is to be fabricated.

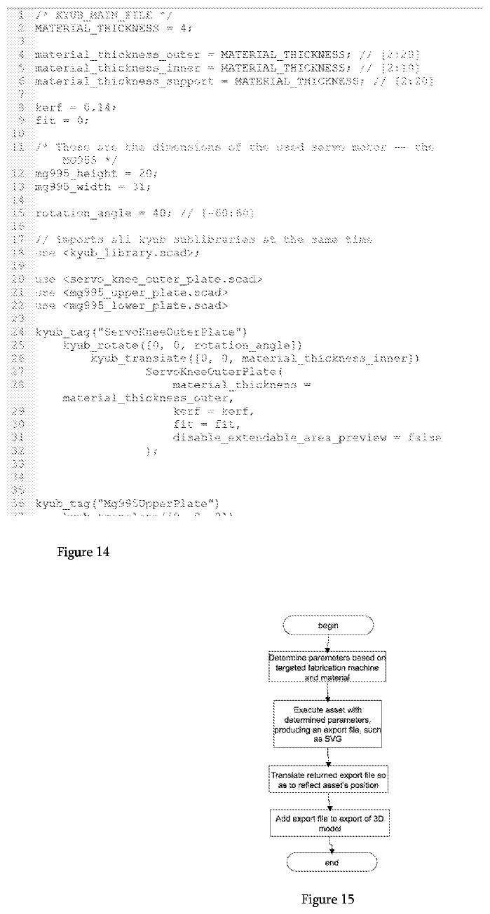

Some embodiments achieve this by expressing the asset using a programming language or scripting languages. A wide variety of programming language or scripting languages are suitable for this purpose, such as, but not limited to JavaScript, TypeScript, C++ and so on. In one embodiment, we use program code in the OpenSCAD format for this purpose. FIG. 14 shows an example asset written in SCAD. Parameters, such as kerf, are defined as variables in the header of the file and will be overwritten during the input process. The ServoKneeOuterPlate( ) function defines the shape of one of the asset's plates by building it with boolean operations of geometries with material-thickness height. From this two-dimensional plate definition, the kyub_translate and kyub_rotate functions are used to define the plate's position in 3D space, thus defining the connectivity of the asset, by building up a transform matrix. The OpenSCAD file can be used to generate the files for the fabrication machine, as well as the visualization files for the interactive editor.

The algorithm shown in FIG. 15 fabricates such an asset.

If the user modifies the model, the asset can update itself to adjust to the changes made to the model.

### Incomplete Assets and Asset Requests

When a user of the interactive editor does not find a desired asset in the asset library, there may create their own or ask someone else or the public to do it. There are three general approaches to doing so:

Depth first: Users may pause their session in the 3D editor and create the asset. In some cases, asset creators will start with a blank template. In many other cases, they still instead start by copying an existing asset of similar type, and replace and tweak until the asset performs the new intended function. Once completed, users may then continue to work on their 3D model. Some embodiments will require users to release the asset to the general public.

Breadth first: users may insert an appropriate placeholder and continue the editing session. A boxel or asset of similar connector structure will often make for a good placeholder. Only later, users may create the required asset and replace the placeholder with it.

Delegation: users may proceed as described above, but instead of implementing the asset themselves, users may request other users to create the asset. Some embodiments allow users to simply post the request to the public; others allow asking specific users to create the asset. Such postings may be pushed to appropriate users us simply published on an appropriate bulletin board or marketplace where qualified users are looking for work.

Different embodiments may offer different ways of specifying desired assets. In one embodiment, designers may simply provide a textual description or sketch or such of the asset they need and then this description is shared or posted. Other embodiments may use a more formal specification, e.g., one where users complement their description with an asset template, which they may construct, query, or pick from a list, etc.

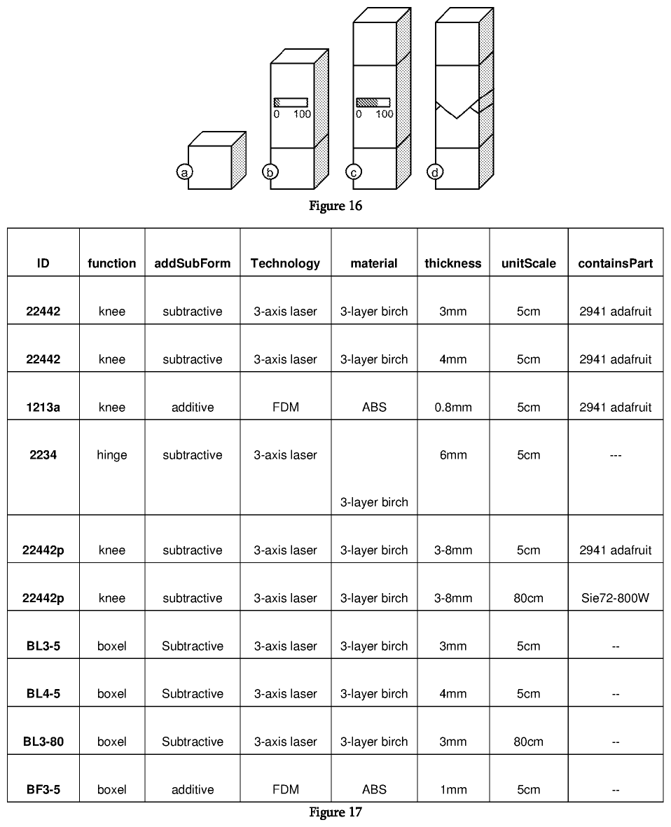

As illustrated by FIG. 16, one benefit of using an asset template is that it allows constructing a blank placeholder asset (or boxel) automatically. (a, b) Users can already embed that placeholder in their designs and thus (c) continue their design process. As shown, the placeholder itself can hold a progress indicator informing the user when an asset maker when progress has been made, e.g., when the task to make the asset has picked by an asset maker and how far it is to completion. (d) Finally, when the asset maker has completed the asset, the newly created asset may automatically replace the placeholder, i.e., without requiring any further interaction by the user.

### Converting 3D Models Based on Assets

Given a specific 3D model for fabrication, there are several reasons a user may want to fabricate different “version” of it, such as the fact that the user may have lost access to a specific fab machine, model, material, or parts that was/were initially used to fabricate the model. Or, the user's requirements may have changed and the user now desires a version that is larger, smaller, sturdier, cheaper, lighter, and so on.

Unfortunately, making such adjustments can be difficult as 3D models for fabrication tend to be highly specific, i.e., they will only fabricate under the very specific circumstances they were designed for. This specificity includes, among others, the factors mentioned above and below:

(1) Additive/subtracting/formative-specific. A model designed for a laser cutter (subtractive process) will not fabricate on a 3D printer (additive process) and a model designed for a 3D printer will not fabricate on a laser cutter. The same holds for mills, knife cutters, and so on.

(2) Fabrication technology-specific. A 3D model designed for 3D printing based on laser sintering may or may not fabricate if the same file is sent to a 3D printer based on fused deposition modeling and the other way around.

(3) Material-specific. A mechanical device, such as a spring, designed to be printed from a stiff plastic, such as ABS will often not work as intended when fabricated from a much less stiff material, such as silicone.

(4) Scale-specific. A 3D model designed at small scale, may fail when scaled up by a large amount, for example, because weight changes more than strength.

(5) Part-specific. A 3D model may make use of a specific part, such as a specific servo motor. When trying to replace the part with a different model, the new part may not fit the 3D model anymore.

and so on.

Today, recreating the 3D model for the new circumstance can be laborious, worst case up to the point where the entire model has to be re-created from scratch.

Prior art on converting 3D models between fabrication methods (such as 3D printing to laser cutting in “Platener: Low-Fidelity Fabrication of 3D Objects by Substituting 3D Print with Laser-Cut Plates, Dustin Beyer, Serafima Gurevich, Stefanie Mueller, Hsiang-Ting Chen, Patrick Baudisch, In Proceedings of CHI 2015”) is a great step in this direction in that it (apart from being limited to a very specific type of conversion, i.e., 3D printing to laser cutters) demonstrates how to convert basic geometry, i.e., polygon meshes. Also, Autodesk 123D offered some similar conversion technology from 3D models to stacks of plates.

But what about embedded objects and all the other aspects that the instant invention expresses in the form of assets?

### Algorithm Based on a Relational Model

We propose solving the conversion issue by replacing assets based on a relational model.

In order to do this, we introduce a larger number of assets, such that the resulting set covers the desired properties we want to convert to. An embodiment designed to allow converting, for example, to 3D printing, has to offer 3D printing assets. We debated assets for laser cutting in detail in SME3M. Creating assets for 3D printing in contrast is straightforward. Given that 3D printing is very versatile, one way of creating assets for 3D printing is to (1) take assets designed for laser cutting or milling etc. as input, (2) unite all their elements using solid geometry operations, and (3) store the result in a 3D format, such as .stl or .obj. The result is a 3D printable file capable of performing the same operation as the laser cutable or millable original. Just like assets for laser cutting, such assets for 3D printing can be added to or embedded into 3D models, and merged into the model using solid geometry operations, such as AND/OR union/interaction, etc. They can be stored in an asset store and retrieved from it and so on.

Yet other assets can be created by combining laser cutting and/or 3D printing with structural elements such as tubes, plates, aluminum profiles, steel profiles, wooden beams, plastic bottles, or any other types of readymade or easily adjustable element. Such methods are particularly suited for creating very large boxels and assets.

The key idea now is to describe all assets as a “relation” (e.g., in the form of a table) containing the fabrication circumstances they were designed for. FIG. 17 shows an example. This small table contains the description of a few assets, each of which is represented as one row here. We can see that, for example, that the first asset (first row) implements a “knee”, which here might be a short ID to mean “a motorized robotic knee joint.” The asset is designed to be manufactured on a 3-axis laser cutter and from 3-layer birch plywood. The unitScale 5cm could, for example, mean that this asset will fits into a single 5×5×5cm boxel. And from the last column we learn that this asset contains an electronic part, namely a specific type of servomotor.

All these are examples, and other embodiments will use different columns and different formats for encoding them. Also, the relation might be implemented as a table, but it could also be stored as anything else, such as a transposed table, a look-up table, a database, a graph structure, a set of rules, a file, markup, implemented in code or script, and so on).

Based on this data structure, we can now perform several transformations. Let us imagine the user has a 3D model that consists entirely of boxels BL3-5 and robotic knees 22442 and that the model consists of general 3D geometry complemented with assets. One way of representing this is as a graph structure with assets being represented as asset data structures or anything that links to them, such as an asset ID.

If the user has run out of 3mm plywood (“3-layer birch”), but still has access to 4 mm plywood, the user will now want to convert the model from 3 mm plywood to 4 mm plywood according to the following algorithm:

(1) Convert 3D geometry, but not the assets, using an appropriate conversion method of choice. For 3D printing to laser cutting, for example, this could be Platener or Autodesk 123D, etc. The resulting model now is in the right format, but the assets will not fit anymore. (2) Traverse all assets: (3) for each asset, query the table (or, in general, the data structure provided by the embodiment) for an asset that fits the existing asset description wherein which the tweaked parameter was replaced with the desired value. Here, this means that the system will query the table, for example, from the top, but with a 4 mm instead of a 3 mm in the thickness column. Luckily an exact match can be found (actually two matches as the parametric model 22442 p fits as well); also for the boxel such as exact match exists. (4) Replace the asset with the match found in step 3.

The model can now be exported and fabricated.

As we see, the table allows us to convert a 3D model by replacing everything beyond basic geometry on per-boxel and per-asset level.

Note how in the specific case where the entire model consists only of boxels and assets, the described method allows converting the entire model without the help of external tools that convert basic geometry.

In the example above, we assumed that the system can always find exact matches. The likelihood of that happening obviously increases the larger the table, so large asset collections are certainly beneficial for this approach.

Still, a perfect match may not always be found. Let's imagine our user has only 6 mm plywood at hand. In order to convert the robotic knee, the system will again query the table. This time there is not exact match, but there are a few almost matches. Some embodiments handle this case by asking the user, e.g., by opening a dialog box asking something like “no exact match found, but here are a few almost matches: please pick one or cancel”, similar to how some word processors and desktop publish systems ask the user how to replace font when a desired font cannot be found.

Other embodiments try to perform the replacement automatically. For that purpose, they compute how bad a fit the retrieved rows would be. One way to do so is to invoke a penalty function with the query row and the retrieved row as parameters; the function then returns a penalty value. This penalty value is some numeric value that expresses how undesirable it is to make the replacement. We use the term penalty in analogy to the penalty value generated by the typesetting program TeX when doing its linebreak. The penalty may also be understood as a (typically negative) utility.

The system will then replace the assets of the original models with their best fit, i.e., the one with the smallest penalty. However, if the returned penalty is above a certain threshold, the system may terminate the conversion as such values would be intentional indicators that the resulting model would perform too poorly to be considered.

There are many ways to compute such a penalty function. It may be stored and executed in terms of code or using data structures. Conceptually, the entire function can, for example, be stored in one huge table that maps the parameters to the penalty. However, because of the large number of parameters this will not always be practical. Instead, the system may break down penalty computation into multiple aspects, each of which computes its own penalty to be aggregated (e.g., summed up) before returning the value.

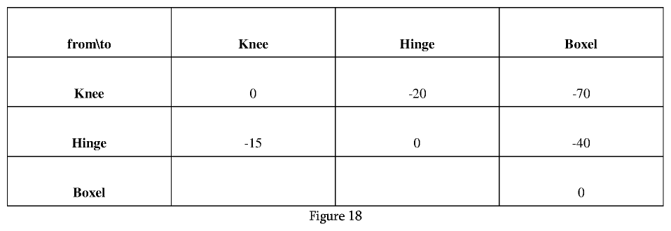

In our example, there is no 6 mm knee asset, but there is an 8 mm hinge. The penalty function may look up the conversion in something like FIG. 18 and find that the replacement of a knee with a hinge would come at a penalty of −20. This value, might, for example, express that the resulting model would not be able to actuate anymore, but could still be used to demonstrate the mobility of what is being built. And assuming that −20 is acceptable, the conversion may actually go through.

This approach is very generic and can be used for a wide range of conversions, including the ones listed above, such as to scale up models (here the small Adafruit servomotor would get replaced by probably huge BL3-80 servomotor). By adding additional columns we can perform additional types of conversion. We may add columns for power, stiffness, and other physical properties (or compute them, e.g., by invoking a physics simulation or looking them up based on the part specification, such as the servomotor) and then we can conversions, such as “make stronger” or “make stiffer”. We can price and then perform “make cheaper”, etc.

Also not shown in the table, but scaling a boxel by a large factor may for actually replace an all-wood boxel with a box implemented as a truss structure, containing plastic pipes, aluminum profiles, system 180 steel frames, and so on.

We can also use this method to convert between fabrication methods and, given that many construction kits also use assets, it allows converting to and from LEGO, fischer technik, industry automation components (such as Festo), or any other construction kit.

Finally, the results of some of the conversions remain compatible with the original model, such as “make stronger”, “make cheaper”, etc. These particular conversions we can also apply locally, i.e., some embodiments may offer a “make stronger” tools and by clicking on an asset, brushing across assets, selecting assets and picking such a function, invoking an on-asset context menu, etc. the respective assets can be altered.

### Conversion of Arbitrary 3D Models

While we have been focusing on converting 3D models designed for fabrication so far, in fact, arbitrary 3D models can be converted for fabrication on a specific fabrication machine.

Such arbitrary 3D models could e.g. also be models originally not designed to be fabricated directly, such as 3D models used for games and videos, CAD plans, drawings and 3D models for architecture, mechanical design, etc.

These 3D models could represent their contents in different ways, e.g. representing a mesh as a list of polygons, as voxels, etc; representing a whole collection of objects as a graph or tree structure; representing objects based on an abstract specification, such as by describing their structure (e,g, IFC files describing buildings by their walls, rooms and annotating doors and windows) or a mixture of all mentioned above.

Such a 3D model could be converted for a specific fabrication machine by using the following algorithm: (1) load 3D model (2) load asset library for the desired fabrication machine (3) extract/convert parts that can be realized with assets for this specific fabrication machine (4) use generic fallbacks for not-yet converted parts (5) export the fabrication-machine-specific model and assets (6) fabricate the model based on that information

As someone skilled in the art will appreciate, the (2) asset library can have any form, such as files stored locally on a file system, a database, a server offering an API, etc. It does not need to be available in its entirety at all times, as it could be queried sequentially.

As someone skilled in the art will appreciate, the (3) extraction of parts that can be realized as assets can be performed in different ways. For instance, some 3D models may already be very abstract, making the extraction step straightforward (e.g. for ICF files for architectural models a system could perform the following: WHEN part is defined as “door”, extract that part using assets that realize “door”, choose the asset that best matches the door's specification and target fabrication machine using e.g. the penalty function described in [00141]). Other 3D models may be less abstract, and assets could extracted by e.g. using pattern-matching, a set of rules, neural networks, etc (e.g. in a STL file that describes the objects as a list of 3D triangles, one algorithm could start by extracting volumes and converting them into the target-machine's artefacts, such as boxels for laser-cutting, and then recognize assets in/on these volumes and add them to the boxel-geometry).

Note that between loading the 3D model and fabricating it, assets may be converted between each other. E.g. a system may have implemented rules to recognize a set of 3D-printed assets, but by converting them to laser-cuttable assets e.g. using the method proposed in [00128], the system would be able to convert a 3D model to laser-cuttable plates without having to implement conversion logic for this specific fabrication machine (laser-cutter).

As someone skilled in the art will appreciate, the (4) fallback implementation for not-yet converted parts could also be implemented using this asset-based approach, e.g. by using assets that match very broadly and thus are able to convert a lot of geometry. For instance, in the context of architectural design, a “wall” asset could be a fully parametric asset (as proposed in earlier) that is programmed to generate a fabricate-able wall of arbitrary shape. Another possible implementation would be to first convert the whole model as a closed box structure, and then refining the converted model by converting individual parts as assets.

What assets are chosen to be used to fabricate a given model can also be influenced by user preferences. E.g. if the user intends to use the fabricated model as a rough prototype, the system may preferably choose assets that fabricate quickly so that the whole model is fabricated in a short amount of time, possibly sacrificing fidelity or detail-richness. As somebody skilled in the art may appreciate, such user-dependent asset selection could be realized by e.g. using different weight multiplicators for different properties calculating the penalty values as proposed in [00144]. E.g. for a “door” in a 3D model, there might be 5 assets that could realize this door for a given fabrication machine. Out of these five assets, the system may calculate user-depending penalty values (see above) and rank the assets based on the result. The asset with the lowest penalty will be used to realize the “door”.

### Asset Store

Embodiments may store assets in different locations. For instance, user-created assets may be stored onto the user's computer and/or any connected removable media device but may also be sent to a server/data center/cloud storage and centrally stored there (online). Assets provided by the embodiments themselves may also be stored online and/or locally on the users machine and/or connected removable media devices.

Embodiments may choose the storage location based on availability, storage speed/caching considerations, and may change the storage place of an asset if deemed necessary, e.g. to make it available to the user more quickly. It may also store an asset multiple times in different locations, e.g. for caching and/or added redundancy.

Embodiments may offer a web platform for users to create, discover, browse, search for, share, download and purchase assets (“asset store”).

Embodiments may offer users to upload their assets in order to try them out and/or showcase them on the platform.

Based on the files and information of the uploaded asset, embodiments may automatically create sites that showcase this asset, e.g. display thumbnails, photos, asset description, assembly instructions, 3D preview, etc.

Embodiments may allow users to extend and modify this information, e.g. adding more photos, by adding/altering this information directly using a user interface on/by the platform.

Embodiments may allow users to search for assets or to list assets according to tags or other relevant properties (e.g. “new today”, “all mechanical assets”, . . . ).

Embodiments may offer users to present themselves, e.g. with a customizable profile page, a list of the user's created assets, a list of the assemblies and projects created by the user.

Embodiments may choose to let users interact with each other. Such an interaction could be done by letting users collect assets in collections and present them (“See Bob's ‘My top 10 robotic assets’”), let users comment, rate, like, recommend, vote on, . . . assets, let users interchange information with each other in a forum, or posts on a profile page, . . .

Embodiments may offer the option to let users pose a question and let other users propose answers and vote/decide on the best answer. Such a question/answer pair may be around an asset (“I am looking for an asset that fixates a DC motor of type ABC123”) and thus contain an asset as a solution (“Out of all motor mounts, this is the best one to fixate the given DC motor”). It may also contain generic non-asset question, or a question whose answer is a assembly created by kyub.

One step further, embodiments may also let users change the given solution, e.g. if an asset (as proposed as a solution) becomes outdated, users may be allowed to update the given asset or model.

Embodiments may allow users to offer a reward for such a solution, giving a financial incentive for other users to create a matching solution (asset/model/other . . . ).

Reward may also be given in the form of virtual experience points, stars, likes, badges, awards.

Embodiments may allow users to download assets in order to test and/or fabricate them.

Embodiments may prevent downloading assets and require users to purchase the right to use them (“paid assets”). Such asset can only be downloaded/fabricated once the user has paid for them. Embodiments may allow users to use the asset within 3D editors and previews, and may restrict only the last export/fabrication steps, allowing users to thoroughly test the asset in the software before purchase, while preventing unlicensed use.

Embodiments may users to offer their assets as paid assets. Such users would benefit financially from their assets being sold, e.g. by getting a fixed amount, a share of the sale price, or any other way of determining a financial compensations.

Embodiments may offer gamification aspects, such as an experience points system, stars, user badges, user awards, user achievements to incentive and reward certain behavior of users on the platform, e.g. reward the creation of assets, answering questions, moderating a forum, etc.

Embodiments may closely integrate the 3D editor interface and the asset store. For instance, they could offer a preview of each asset within a (minimized) version of the 3D editor, would allow drag-and-dropping assets/models/assemblies from/to the editor and the asset store, may replace certain parts of the asset store with a 3D editor showing the asset/model in question.

Reference in the specification to “one embodiment”, “an embodiment”, “various embodiments” or “some embodiments” means that a particular feature, structure, or characteristic described in connection with these embodiments is included in at least one embodiment of the invention, and such references in various places in the specification are not necessarily all referring to the same embodiment.

All publications, patents, and patent applications cited herein are hereby incorporated by reference in their entirety for all purposes to the same extent as if each individual publication, patent, or patent application were specifically and individually indicated to be so incorporated by reference.

Some portions of the detailed description herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

1-27. (canceled)

28. A reusable component for embedding into 3D models, comprising:
an export file that describes contents that can be fabricated on a targeted fabrication machine,
wherein in response to a fabrication request all or part of the geometry represented by the export file is translated and/or rotated to reflect the position and/or orientation of the reusable component with respect to the 3D model in which the reusable component is embedded, and then integrated at that position and orientation into the export of the 3D model.

29. The reusable component of claim 28, further comprising:
an appearance file that can be positioned in a 3D models using a 3D editor,
wherein positioning the appearance file within the 3D model produces the parameters required to position all or part of the geometry represented by the export file.

30. The reusable component of claim 28, further comprising a searchable description.

31. The reusable component of claim 28, further comprising an interface specification that limits where the reusable component can be placed during interactive editing.

32. The reusable component of claim 29, wherein the appearance file is a 3D model.

33. The reusable component of claim 28, wherein the targeted fabrication machine is a laser cutter.

34. The reusable component of claim 28, wherein the targeted fabrication machine is a 3D printer.

35. The reusable component of claim 28, wherein the targeted fabrication machine is a milling machine.

36. The reusable component of claim 28, wherein the export file contains one or more line drawings.

37. The reusable component of claim 28, wherein the export file is a piece of program code or script.

38. The reusable component of claim 37, wherein the program code receives parameters that al-low the reusable component to adapt to the model.

39. A system for automated tweaking of 3D models comprising:
an asset conversion mechanism to compare subparts of an asset to a plurality of library assets and to replace each subpart of the asset with a library asset that better matches a criterion passed into the conversion as a parameter.

40. The system of claim 39, further comprising a conversion mechanism for the main geometry.

41. The system of claim 39, wherein the conversion is from laser cutting to 3D printing.

42. The system of claim 39, wherein the conversion is from laser cutting to milling.

43. The system of claim 39, wherein the conversion is from 3D printing to laser cutting.

44. A method for generating a reusable component comprising:
generating an export file executable by the targeted fabrication machine,
wherein all or part of the geometry represented by the export file allows translation or rotation or both to reflect a position of an asset in a 3D model containing the asset.

45. The method of claim 44, wherein the 3D model comprises plates.

46. A method for fabricating physical 3D models using a laser cutter, the method comprising:
projecting surfaces into a 2D coordinate system; and
introducing carpentry joints between pairs of the projected surfaces that were adjacent in the 3D model.

47. The method of claim 46, wherein the carpenter joints are finger joints.

48. The method of claim 46, further comprising:
retrieving the export files of each reusable component,
translating and/or rotating these export files according to the relative position and orientation of the respective reusable component with respect to the 3D model, and
integrating the result into the export file that represents the 3D model.
